(19) United States
(12) Patent Application Publication
(10) Pub. No.: US 2019/0066122 A1
(43) Pub. Date: Feb. 28, 2019

(54) SYSTEM FOR REMOTELY MONITORING EMISSIONS PERFORMANCE OF A VEHICLE

(71) Applicant: American Gas & Technology, Dallas, OR (US)

(72) Inventors: Raymon E. Tate, JR., Dallas, OR (US); Michael R.L. Tate, Dallas, OR (US); Thomas A. Tate, Isleton, CA (US); William J. Briskey, Monmouth, OR (US)

(21) Appl. No.: 16/113,573

(22) Filed: Aug. 27, 2018

Related U.S. Application Data
(60) Provisional application No. 62/551,488, filed on Aug. 29, 2017.

(51) Int. Cl. G06Q 30/00; F02B 77/08; G07C 5/00; G07C 5/02

(52) U.S. Cl. CPC G06Q 30/018; F02B 77/083; G07C 5/02; G07C 5/008; F02B 77/086

(57) ABSTRACT

A system for monitoring the emissions performance of a vehicle by scanning an OBD system of the vehicle and transmitting the information to a hub. A determination is made whether the engine of the vehicle is in a non-compliant state. The non-compliant state including a failure of an oxygen sensor that causes a hub to control a refueling dispenser that presents a message confirming that the vehicle is in the non-compliant state on a display at the refueling dispenser and automatically levies a fine against the owner of the vehicle for being in the non-complaint state when the user or owner pays to refuel their vehicle. The fine is remitted to the regulating authorities.

### BACKGROUND

The present application relates to vehicle emission monitoring systems and more particularly remote monitoring systems.

One of the most important aspects of any vehicular combustion motor is the desired air-to-fuel ratio in the engine cylinder. Having the proper amount of combustible fuel to the amount of air needed to sustain the burning of the combustible fuel is very important for performance reasons. Having excess air (a “lean mixture”) will cause combustion to be very rapid and hot, while having excess fuel (a “rich mixture”) will cause combustion to be very slow and cool.

Having the proper amount of combustible fuel to the amount of air needed to sustain the burning of the combustible fuel is also very important for limiting vehicular emissions. In a combustion reaction, oxygen in the air will react with the fuel to produce carbon dioxide and water, which are then expelled from the vehicle cylinder. When there is not enough oxygen in the vehicle cylinder to react completely with the fuel, incomplete combustion will occur, which will not only release less energy than complete combustion, but will release harmful carbon monoxide gas.

Generally, a stoic air-to-fuel ratio, wherein just enough air is introduced to completely burn the fuel being used in the combustion engine, is most optimal for general performance when cruising and idling. Such a ratio ensures that the vehicle is emissions-friendly and fuel-efficient (more so than a rich mixture) and ensures that the engine does not run hot enough to risk damage to the engine components (as may be the case with a particularly lean mixture). However, in some circumstances, such as during startup or to increase the power put out by the engine, a richer mixture can be used.

The air-to-fuel ratio is typically measured on a “lambda” scale. A lambda of 1.0 is a stoic air-to-fuel ratio where neither reactant is present in excess, a lambda above 1.0 is a “lean mixture” where excess oxygen is present, and a lambda below 1.0 is a “rich mixture” where excess fuel is present.

The point at which lambda 1.0 is achieved depends on the chemical composition of the fuel used in the engine. For example, lambda 1.0 is achieved in a gasoline engine when approximately 14.7 pound-mass (lbm) of air is present for every lbm of gasoline. For natural gas, lambda 1.0 is achieved when approximately 17.2 lbm of air is present for every lbm of natural gas. For ethanol, lambda 1.0 is achieved when approximately 9 lbm of air is present for every lbm of ethanol. Combined fuels, such as gasoline that has been mixed with a quantity of ethanol, have still different performance.

As discussed, a lambda of around 1.0 is generally optimal for most cruising and idling conditions. For a gasoline engine, this may be an air-to-fuel ratio of 14.7:1. However, this may sink lower when warming up the engine or when the engine has been tuned for maximum power; in such cases, lower lambda values (such as a lambda value of 0.8, or a ratio of approximately 12:1) may be achieved.

In most engines, the desired lambda ratio may be monitored and maintained by the use of an oxygen sensor (O2 sensor) or lambda sensor. These sensors began being used in vehicle engines in 1976 and have been made virtually mandatory for all cars and light trucks manufactured since 1981. The enactment of the OBD-II regulations, applicable to cars manufactured from 1996 onward, has caused many engine manufacturers to include multiple O2 sensors—often two, but sometimes as many as four. (These sensors are typically zirconium ceramic bulbs installed inside the exhaust of the vehicle, which may be configured to receive airflow and to produce a voltage based on the lambda of the exhaust, such that they produce a first voltage at a first lambda level and a second voltage at a second lambda level. In many vehicles, there may be a sensor right after each cylinder bank of the engine, and after each of the vehicle's catalytic converters so as to monitor the operating efficiency of the converter.)

In vehicles equipped with an O2 sensor, the vehicle's onboard computer interprets the output of the O2 sensor and uses this sensor output (often alongside other sensor output) in order to regulate the fuel mixture of the engine, which is referred to as the “feedback control loop.” In response to a sensor reading, the computer adjusts the fuel mixture, which then yields a new sensor reading that is used to further adjust the fuel mixture. This is referred to as a “closed-loop” operation. In such a “closed-loop” operation, the vehicle computer may constantly switch back and forth between applying a slightly richer mixture and a slightly leaner mixture in order to keep the lambda of the vehicle as close as possible to 1 (or to whatever the desired value may be if another value is desired).

However, it is not always possible to operate a vehicle in a “closed-loop” configuration. In particular, when a vehicle first starts, no sensor output will be provided by the oxygen sensor (and it may further be desirable to use a richer mixture so that the vehicle engine reaches operating temperature more quickly) and as such the vehicle computer will need to provide an air-fuel mixture without the benefit of the O2 sensor output. Likewise, oxygen sensors have a limited lifespan of several years, and can wear out multiple times over the lifetime of a vehicle. While these sensors can be replaced, it would be undesirable to have the vehicle become inoperable as soon as an oxygen sensor wore out, and as such, the vehicle must also operate without any functional O2 sensors in the engine.

When the sensor is malfunctioning, when a cold engine has been first started and no sensor data has yet been provided, or otherwise when no signal has been received from the O2 sensor, the vehicle's onboard computer is typically configured to use a default fixed air-fuel mixture, which is typically a rich mixture. This rich mixture offers poorer performance from a mileage and emissions perspective, but ensures that the vehicle can be started and that the vehicle has sufficient amounts of power during the course of its operation. Such a scenario is called “open-loop” operation, because no input is provided from the O2 sensor that would allow the computer to regulate the fuel mixture.

It is generally undesirable for a vehicle to spend much time in “open-loop” operation. Doing so can cost the owner of the vehicle more money, as the vehicle consumes more fuel than would be necessary if the vehicle were in “closed-loop” operation, and can be harmful for the environment, because the vehicle operates using a richer fuel mixture than optimal and thus outputs more CO than optimal. In many cases, when the vehicle needs to comply with emissions standards, the failure of a sensor and the operation of the vehicle in “open-loop” mode can put the vehicle out of compliance with emissions standards and make it illegal to operate.

This means that it is desirable to catch sensor problems in the engine as soon as possible. While, typically, a failure of the oxygen sensor is the most likely culprit for an engine that fails to go into “closed-loop” operation, other failures can also be at fault. For example, a bad coolant sensor can also prevent an engine from going into “closed-loop” operation, because the computer may also consider the temperature of the engine coolant before determining whether to go into closed-loop operation; failures in other sensors, such as a failure in the throttle position sensor, can also send the vehicle into open-loop operation. A failure of any important sensor will likely result in a “Check Engine” light (or “malfunction indicator lamp (MIL),” or “idiot light”) coming on, indicating to the operator of the vehicle that there is something wrong with some part of the engine.

While this at least serves to indicate to the operator of the vehicle that their engine is not functioning optimally and that they need to fix one or more of its components to restore it to full working order, it does not directly tell the operator what is wrong with the engine. At best, most “Check Engine” lights will have multiple colors or stages that indicate to the operator what the severity of the problem is. (For example, the “Check Engine” light may illuminate steadily when a minor fault not necessarily directly related to the engine, such as a loose gas cap, is detected, and may flash when a more severe problem thought to require immediate service is detected.)

In order to determine what the precise nature of the problem is, an operator of a vehicle having an illuminated “Check Engine” light will typically have to make use of the vehicle's On-Board Diagnostics (OBD or OBD-II) system. Such systems are in use in most cars, trucks, and other light vehicles on the road today. OBD-II, in particular, provides monitoring of almost the entire engine, as well as parts of the chassis, body, and accessory devices, and further monitors the diagnostic control network of the vehicle.

OBD-II-enabled cars are each required to have an OBD-II connector, also called a J1962 connector, located in the passenger compartment such that it is easily accessible from the driver's seat. Generally, the connector is located under the dash, or somewhere near the ashtray if one is provided. An OBD-II scanner may be connected to the OBD-II connector; the OBD-II scanner may then display a readout code indicating the nature of the problem identified by the “Check Engine” light, may identify the problem by a text display, or may provide further details, typically depending on the complexity and cost of the scanner.

While a vehicle operator may be able to determine from the use of an OBD-II scanner whether certain sensors or other vehicular devices are operating or have failed, this is not always done. An appreciable fraction of cars on the road continue to have the “Check Engine” light on for months at a time, and the operators of these vehicles likewise go for weeks without determining what the problem is. This may be because, for example, the vehicle operator does not own an OBD-II scanner that would let them identify what the problem is, does not own a sufficiently complex OBD-II scanner to provide them with meaningful data, does not have the money to bring the vehicle to a repair shop that will charge them a fee to determine what the problem is, or does not have the time to figure out what the problem is. This means that an estimated 13% of all vehicles are being driven with one or more noteworthy engine problems, including O2 sensor failures that would lead to the vehicles having heightened emissions.

Accordingly, there is a need for a monitoring system that is not limited as such.

### SUMMARY

A system for remotely monitoring the status and functionality of certain engine sensors related to the state of the engine is disclosed. Such a system may be used in order to monitor the emissions performance of a vehicle and provide immediate feedback to the vehicle user. Such a system may include a scanner device located on the vehicle and a communication hub external to the vehicle that may be provided as part of a system as discussed herein.

According to an exemplary embodiment, a scanner device is provided that may be coupled to an OBD-II connector or similar diagnostic connector of a vehicle. The scanner device may then be communicatively linked by a physical connection through the refueling nozzle or separate cable, or a wireless connection with a hub at a refueling station, for example. When the user's vehicle enters the fueling station, the hub may provide the user with immediate feedback as to the nature of the engine problem or other problem that has caused the “Check Engine” light to come on, or may provide the user with feedback about any other problems that may be detected by the scanner that may not be associated with emissions. This feedback may come in the form of, for example, a printed slip at the hub having the problem information on it, a visual display being provided on a screen of a refueling dispenser, an email sent to the vehicle owner, or even a fine or fee that may either assessed through a separate communication sent to the vehicle's owner, or through an automatic increase of the price the user must pay to refuel. In some exemplary embodiments, the hub or scanner may provide further information to the user, such as the names or contact information of nearby repair shops, estimated repair costs, or may provide the user or owner of the vehicle with an option to make an immediate appointment at a repair shop or place an order for replacement parts. The hub may also be a user's cellular-enabled mobile device, which connects to the scanner via short range communications, such as Bluetooth, etc., and which may further connect to a remote service for processing the problem information and acting accordingly in response thereto, as discussed herein.

The OBD scanner may further have the analysis capability, which could capture, analyze, and store data from the vehicle to provide other valuable historical information to the owner. For example, if mileage performance were captured and combined with the engine load during the period of time between refuelings, it can be useful in helping identify changes in performance and provide notices to give the user an opportunity to respond early. Since current OBD systems only warn the operator when conditions pass a threshold or they may not analyze some conditions that would be beneficial, it would be valuable to look for trends and make these available in a useful manner to the vehicle owner/operator.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a system for remotely monitoring emissions performance of a vehicle.

FIG. 2 is an exemplary embodiment of a system for remotely monitoring emissions performance of a vehicle.

FIG. 3 is an exemplary embodiment of a system for remotely monitoring emissions performance of a vehicle, in which the scanner device may be communicatively coupled to a mobile device of a vehicle user.

FIG. 4 is an exemplary embodiment of a system for remotely monitoring emissions performance of a vehicle, in which the hub may be communicatively coupled to a mobile device of a vehicle user.

FIG. 5 is an exemplary embodiment of a system for remotely monitoring emissions performance of a vehicle, in which the hub may have an Internet connection.

FIG. 6 is an exemplary embodiment of a system for remotely monitoring emissions performance of a vehicle, in which the hub may control the operation of a refueling dispenser.

FIG. 7 is an exemplary embodiment of a system for remotely monitoring emissions performance of a vehicle, in which a local connection may be substituted for an Internet connection.

FIG. 8 is an exemplary flowchart depicting a method for remotely monitoring emissions performance of a vehicle using a system as described herein.

FIG. 9 is an exemplary flowchart depicting a method for remotely monitoring emissions performance of a vehicle using a system as described herein.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, to the extent that the devices described in the present application are configured to perform one or more actions or a sequence of actions, the sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter, and all of which are technical in nature or operation to address the technical deficiencies exhibited by known vehicle scanners. In addition, for each of the embodiments described herein, the corresponding form of any such embodiments may be described herein as, for example, “logic configured to” perform the described action.

According to an exemplary embodiment, and referring generally to the Figures, various exemplary implementations of a system for remotely monitoring emissions performance of a vehicle may be disclosed. In some or all of the exemplary embodiments, such a system may monitor the emissions performance of a vehicle by monitoring the operability and output of one or more engine sensors, such as the O2 sensor or the coolant sensor, or by monitoring an on-board diagnostic output specifying whether the engine is operating in an open-loop or closed-loop state.

For example, according to an exemplary embodiment, a system may monitor, in an OBD-II-enabled system, the Mode 1 PID 03 data of the OBD system (that is, the on-board diagnostics Parameter ID 03 data) in order to determine whether the engine is operating in an open-loop state or a closed-loop state. According to the standard OBD-II PIDs as defined by SAE J1979, a Mode 1 PID 03 request from an OBD-II system may return two bytes indicating the fuel system status of the first fuel system and the fuel system status of the second fuel system (if one exists). The first byte may have a value of 1, 2, 4, 8, and 16, based on one bit at most being set, with any other value being an incorrect response. (The second byte may be encoded in the same manner as the first byte, but may reflect the second fuel system, instead.)

A response of “1” in response to a request for Mode 1 PID 03 data may indicate that the engine is in open loop due to insufficient engine temperature, which typically means that the vehicle has just started up and has not yet reached its desired operating temperature. A response of “2” may indicate that the engine is in closed loop and is using O2 sensor feedback to determine the proper fuel mix, which typically means that the vehicle is operating normally, has started up, and is cruising or idling. A response of “4” may indicate that the engine is in an open loop state for one of two reasons; first, the engine may be in an open loop state due to engine load (necessitating that a richer fuel mixture be applied for additional power), and second, the engine may be in an open loop state due to a fuel cut due to deceleration. As such, a response of “4” typically means that the vehicle is accelerating or decelerating. All three of the above response codes can be expected to be encountered during normal operating conditions.

Mode 1 PID 03 also includes two other response codes that indicate some sort of failure in the engine, and which may be specifically looked for by the present system in some exemplary embodiments thereof in order to determine if the engine has suffered a failure that would lead to undesirable emissions output. A response of “8” may indicate that the engine is in an open loop state due to a system failure. Likewise, a response of “16” may indicate that the system is in a closed-loop state and is making use of at least one O2 sensor, but that there is some kind of fault in the feedback system and the system is not necessarily performing as it should. (For example, in systems with more than one O2 sensor, one of the O2 sensors may have failed.)

According to an exemplary embodiment, an O2 sensor (or other engine sensor) may also be directly monitored by a system using the OBD-II protocol. For example, a Mode 1 PID 14 request sent to the OBD system may request the status of the first oxygen sensor of the vehicle, and the OBD system may return the oxygen sensor voltage and the short-term fuel trim. The same may be true for a Mode 1 PID 15 request (which may be for a second oxygen sensor) and so forth. Likewise, a Mode 1 PID 24 request sent to the OBD system may request the fuel-air equivalence ratio of the first oxygen sensor of the vehicle as well as the voltage, and the same may be true for a Mode 1 PID 25 request (which may be for a second oxygen sensor). Other requests may likewise be made of the first oxygen sensor or any other sensors for any data collected by the sensor (such as, for example, the oxygen sensor current), as may be desired.

In an exemplary embodiment, data collected from the sensor by the scanner may be used by the scanner, hub, and/or the remote system to determine information like the probable age or condition of the sensor as well as the nominal output of the sensor. For example, in some exemplary embodiments, an older sensor or the sensor of an older vehicle may have a lesser sensitivity or a greater response time than a newer sensor, or may otherwise have certain problems with its function. If the oxygen sensor becomes less responsive due to old age or contamination, it may have adverse effects on the closed-loop operation of the system; for example, if the sensor develops a greater response time due to old age or contamination, the computer system of the vehicle may be unable to properly adjust the fuel mixture entering the engine quickly enough to maintain a lambda of 1 in the engine or otherwise maintain the engine at optimal or desired conditions. In some exemplary embodiments, the data from the sensor may be combined with other data from the engine, such as data from other oxygen sensors if multiple oxygen sensors are present, or data from the vehicle's computer indicating when a change in fuel composition was made (which may be used to determine a predicted sensor response that may be compared to the observed sensor response), in order to determine the health of the sensor and whether it is likely to be producing accurate data. In some exemplary embodiments, a user may be alerted about a sensor that is determined to be inaccurate or is determined to be likely to be near failure, if desired.

According to an exemplary embodiment, once the system has obtained data as to whether the engine is in a closed-loop state or an open-loop state, or has obtained data regarding the operability and output of one or more of the oxygen sensors, an emissions output of the vehicle may then be determined or may be estimated. The determination of the emissions output of the vehicle may then be compared to a threshold value in order to determine whether the vehicle has emissions above that value or below it. The emissions determination may, for example, be based on a determination of the state of the oxygen sensors over time or a state of the engine over time, such that an engine that is briefly in an open-loop state during startup is not determined to be in danger of exceeding an emissions threshold but a vehicle that is in an open-loop state throughout its operation may be determined to be in danger of exceeding the emissions threshold or may be determined to be over it. In another exemplary embodiment, the fuel efficiency of the vehicle may instead be determined, or may additionally be determined, and the fuel efficiency of the vehicle may likewise be compared to a threshold value.

In some exemplary embodiments, when it is determined that an emissions output exceeds the threshold value, when it is determined that the emissions output has exceeded the threshold value for an undesirable period of time, or that another undesirable engine state is present or has been present for a time period (such as, for example, a state of having a fuel efficiency less than the threshold value), the user may be alerted of the fact that their vehicle is outputting excess emissions or the fact that their vehicle is operating at an undesirable level of fuel efficiency. In some exemplary embodiments, this alert may be provided to the user by, for example, lighting another light separate from the “Check Engine” light which corresponds to the alert, or providing the alert on a graphical display of the vehicle, or through another method, such as may be desired.

In some exemplary embodiments, when it is determined that an emissions output exceeds the threshold value or that another undesirable engine state is present, this information may be communicated to an external device. For example, according to an exemplary embodiment, this information may be communicated to a mobile device of the user of the vehicle via some electronic communications medium; for example, this may be done through an application that the user has installed to communicate with the emissions monitoring system, or may be done through another form of electronic communication such as an SMS text message delivered to the user's device, such as may be desired. In another exemplary embodiment, this information may be communicated to a device that the user must interact with in order to continue operating the vehicle, such as, for example, a fueling dispenser or other service station hardware, a toll booth that the vehicle must pass through, or a wireless toll payment unit (such as an EZ-PASS) installed in the user's vehicle. According to another embodiment, the vehicle's information may also be communicated via Internet or other methods of communications to locations and/or a data repository to store or retrieve historical data that may be accessed by monitoring agencies that could be automatically notified of a vehicle's condition. In some exemplary embodiments, this device may then provide the user with a warning on a device display, or may add an additional charge or fine to the user's fee for using the device (such as, for example, the amount the user is charged for refueling the vehicle, or the amount the user pays to go through a toll road). A historical profile of speeds and distances traveled may also be created which could be useful information for the owner/manager of a fleet of vehicles.

A national and/or regional assessment structure may be implemented to assess varying rates to the user according to an agreement between the fueling station(s) owner, nation-wide data collection system, and regulating agency. For example, an owner may get a warning that they will have to pay more in the form of fines if they don't get the problem fixed within x time, y fill-ups, or z miles, and this could vary depending on the vehicle configuration or if the vehicle is out of its home area (giving the owner time to return to where their mechanic is located). In another example, the fine could increase over time. In yet another example, the car may not be allowed to be fueled after a hard limit.

In another exemplary embodiment, the device may impose an access restriction on the user's vehicle until the emissions monitoring system ceases indicating that the user's vehicle is noncompliant, or until the emissions monitoring system indicates that the user's vehicle is compliant. For example, in some exemplary embodiments, a fueling station dispenser may not dispense fuel to a user's vehicle if it has been operating entirely in an open-loop configuration, or may dispense only a limited quantity of fuel. Alternatively, the user of a vehicle that is noncompliant may be granted a “bye” for a period of time (e.g., two weeks), giving the user a chance to fix the problem. This information may be stored in the vehicle's scanner device or external to the vehicle in a database or other location accessible by the communication hub. Each time the vehicle refuels, the vehicle's historical record may be accessed so that in the event that the period of time has lapsed and the user hasn't fixed the problem, the user may be fined or other action taken.

Likewise, a toll road may not allow a user's vehicle to access it if the vehicle is outputting an unacceptable amount of emissions (or has a lower-than-threshold fuel efficiency or otherwise has an undesirable engine state), which may be done, for example, in order to control emissions levels in a certain area. This may force the user to bypass the toll road. In another exemplary embodiment, a toll booth may instead be a security station that controls access to an area but does not charge a fee; such a station may be present, for example, at the gate of a gated community, and may control emissions levels by ensuring that vehicles operating in an open-loop state and having high CO emissions cannot enter the community.

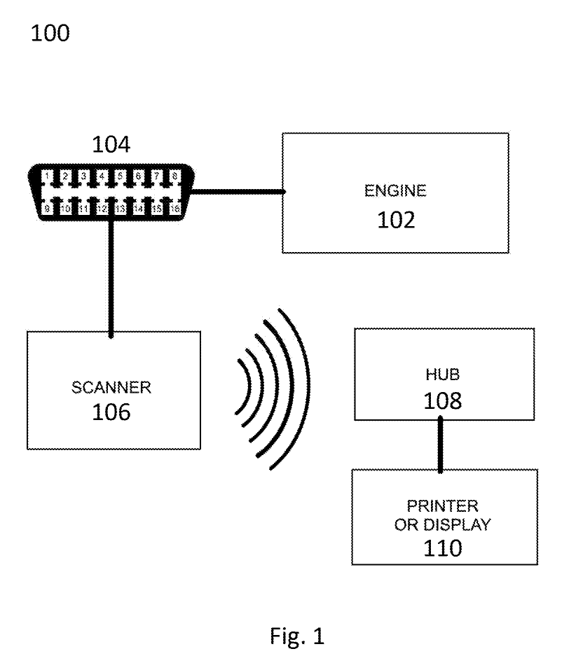

Turning now to exemplary FIG. 1, FIG. 1 displays an exemplary embodiment of a system for remotely monitoring the emissions performance of a vehicle 100. According to an exemplary embodiment, a system for remotely monitoring the emissions performance of a vehicle 100 may be communicatively coupled to an on-board diagnostic system of a vehicle, for example through an OBD or OBD-II port of a vehicle 104, which may in turn be coupled to an engine 102 of a vehicle, or specifically to one or more sensors disposed within or otherwise configured to monitor the engine 102 of a vehicle.

According to an exemplary embodiment, a scanner 106 may be coupled to an OBD-II port of a vehicle 104. In an exemplary embodiment, the scanner 106 may be configured to periodically poll the OBD system of the vehicle or one or more sensors of the vehicle with one or more PID codes as discussed herein, and may be configured to periodically retrieve the OBD-II output of the vehicle that is sent in response to the PID requests.

According to an exemplary embodiment, the scanner 106 may be equipped with a wireless transmitter which may be used to transmit data to a receiver or hub 108 just outside the vehicle. For example, according to an exemplary embodiment, the scanner 106 may be communicatively coupled with a Bluetooth transmitter or another general-purpose wireless transmitter, which may be, for example, disposed within or coupled to the scanner 106. In another exemplary embodiment, the scanner 106 may be communicatively coupled with a vehicle-to-vehicle (V2V) transmitter of the vehicle or another similar system integrated with the vehicle. It may be appreciated that the scanner could also refer to, or be a component of, a data acquisition system that is used to read, access, process, and/or store data from the vehicle. Further, it should also be appreciated that scanner 106, or a data acquisition system, may also function in a wired fashion. For example, a wire could be utilized to couple any elements described herein or otherwise provide data transmission capabilities.

According to an exemplary embodiment, the scanner 106 may communicate with a hub 108, which may in turn be coupled to one or more other systems, such as a printer or display 110. For example, according to an exemplary embodiment, the scanner 106 may communicate via a short-range wireless connection with a hub 108, which may be disposed near the vehicle; the hub 108 may in turn communicate via a longer-range wireless connection (or other connection) with a remote server, on which information reported by the scanner 106 may be stored, in example, for use by the vehicle owner or regulatory agency.

An OBD scanner with analysis capability could capture, analyze, and store data from the vehicle to provide other valuable historical information to the owner. For example, if mileage performance were captured and combined with the engine load during the period of time between refueling, it can be useful in helping identify changes in performance and provide an opportunity to respond early. Since current OBD systems only warn the operator when conditions pass a threshold or they may not analyze some conditions that would be beneficial, it would be valuable to look for trends and make these available in a useful manner to the vehicle owner/operator. For example, artificial intelligence and/or machine learning may be used to analyze vehicle history data to determine these trends.

In some exemplary embodiments, further action other than printing a notice or displaying a notice on the printer or display 110 may be taken. For example, according to an exemplary

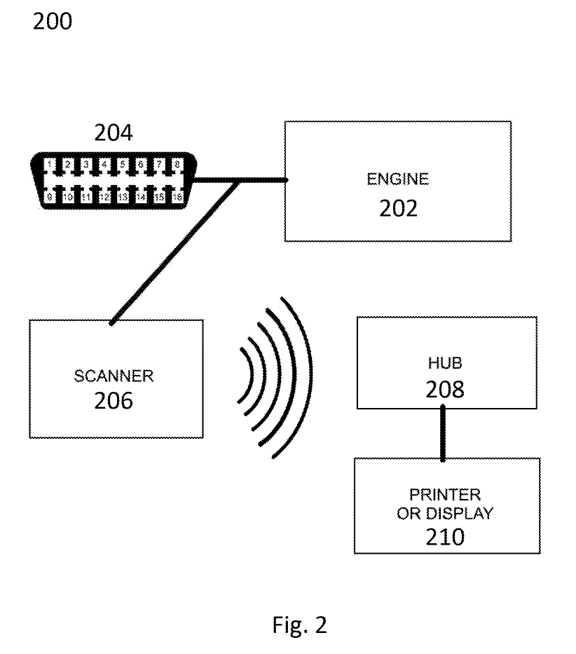

Turning now to exemplary FIG. 2, FIG. 2 displays an exemplary embodiment of a system for remotely monitoring the emissions performance of a vehicle 200. According to an exemplary embodiment, instead of being coupled to an OBD-II port 204, a scanner 206 may be spliced into a connection between an engine 202 and an OBD-II port 204 or may otherwise be integrated with a connection between an engine 202 and the OBD-II port 204. In this manner, the scanner 206 may bypass the OBD-II port 204 when communicating with the engine 202 or with the sensors disposed therein; this may allow a user to read the OBD-II port 204 with an OBD reader tool while allowing the scanner 206 to simultaneously broadcast data (such as a sensor output or an emissions determination) to a hub 208 and printer or display 210.

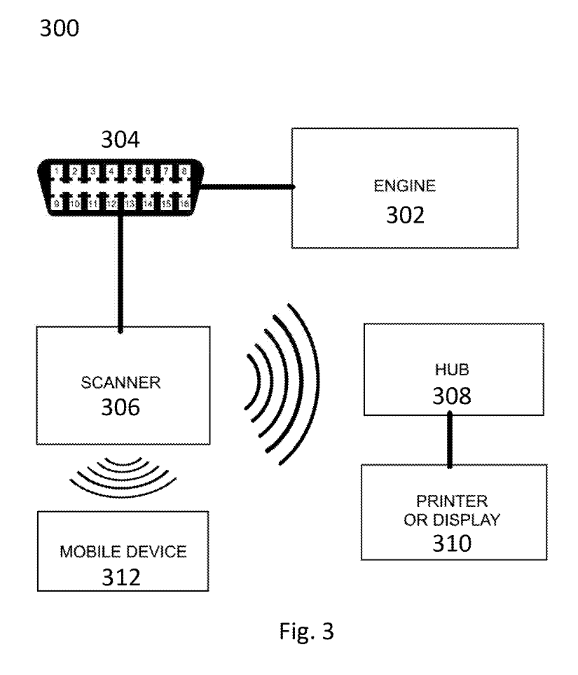

Turning now to exemplary FIG. 3, FIG. 3 displays an exemplary embodiment of a system for remotely monitoring the emissions performance of a vehicle 300. According to an exemplary embodiment, a scanner 306 may be configured to broadcast to an external device, such as a mobile device of a user 312, as well as to a hub 308. In some exemplary embodiments, a wireless connection between a scanner 306 and a mobile device 312 may be based on any wireless communications protocol, which may be the same protocol or a different protocol as is used to communicate with the hub 408. For example, in an exemplary embodiment, a Bluetooth connection may be used; in another exemplary embodiment, near-field communication may be used, such that the user may see the data being broadcasted by the scanner 306 or available to the scanner 306 by bringing their mobile device 312 proximate to the scanner 306.

According to an exemplary embodiment, a user may have an application on their smartphone or tablet that may allow them to read and interpret PID codes from the OBD system 304, and the scanner 306 may be configured to connect to the mobile device of the user 312 and provide the PID data to them. In another exemplary embodiment, the scanner 306 may perform all necessary interpretation and may broadcast the interpreted data to a mobile device 312 of the user, as may be desired. In another exemplary embodiment, the scanner 306 may broadcast the interpreted data to a mobile device 312 located in the vehicle, such as, for example, a graphical display located in the vehicle, which may likewise be able to interpret the PID data if such is desired.

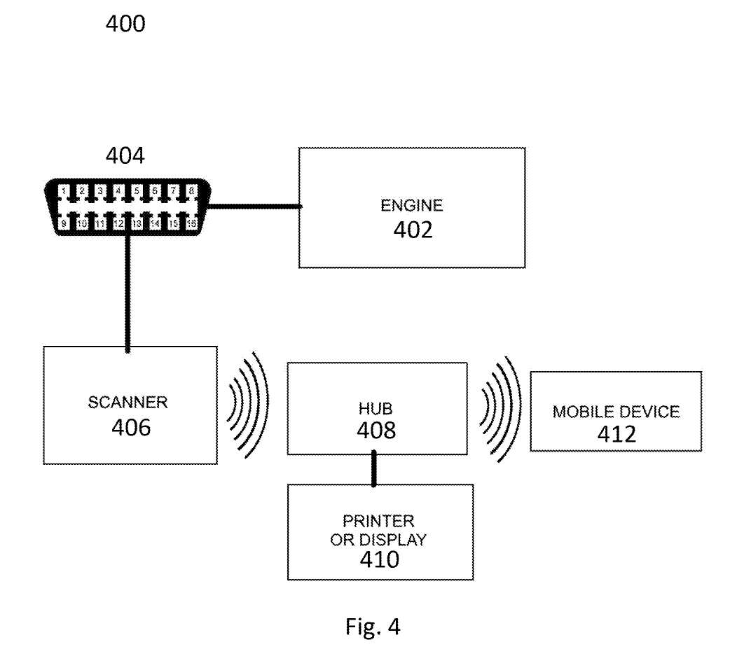

Turning now to exemplary FIG. 4, FIG. 4 displays an exemplary embodiment of a system for remotely monitoring the emissions performance of a vehicle 400. According to an exemplary embodiment, instead of, or in addition to, the scanner 406 being configured to communicate with a mobile device 412, the hub 408 may instead be configured to communicate with a mobile device 412. For example, according to an exemplary embodiment, a scanner 406 may broadcast data to the hub 408, which may then communicate with all other nearby devices, such as a mobile device 412 of the user, or any other nearby devices such as a computer system of a service station.

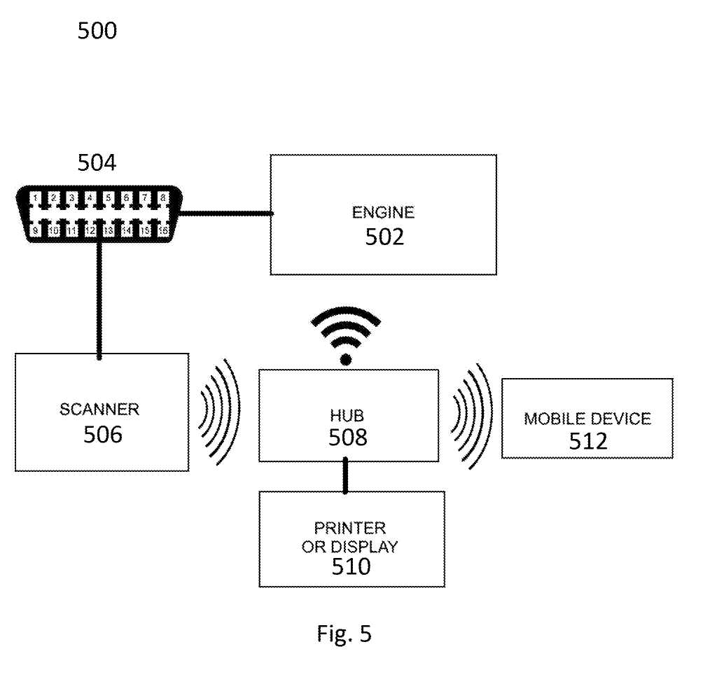

Turning now to exemplary FIG. 5, FIG. 5 displays an exemplary embodiment of a system for remotely monitoring the emissions performance of a vehicle 500. According to an exemplary embodiment, a hub 508 may be further configured to connect to a network having one or more other devices, such as the Internet or a local network of a service station. For example, in an exemplary embodiment, a hub 508 may be configured to connect to a remote server, and may upload data read from a scanner 506 to the remote server.

In some exemplary embodiments, the remote server, or another device or the hub 508, may be configured to then further communicate with a user of the vehicle. For example, according to an exemplary embodiment, when the remote server receives a communication from the scanner 506 which indicates that the engine 502 has one or more failed sensors, the remote server may then contact the owner of the vehicle, for example, by email, SMS text messaging, or through another communications medium, such as may be desired. A user may be able to (or be required to) register their own home location or maintenance choices to the remote server. The server may also be configured to provide further communications or to make recommendations. For example, according to an exemplary embodiment, the server may determine where a “home address” of the vehicle is, if such information can be obtained from the Internet or from the output of the scanner 506, and may then determine the locations of one or more auto repair shops nearby where the vehicle's home address is. The server may then provide these recommendations to the user.

In an exemplary embodiment, a hub 508 may also make use of an Internet connection to provide an updated response or to provide updated feedback to a user. The user may not be the owner, say if the vehicle was owned by a business. So automatic notification to the owner could also be accomplished via email or other means. For example, according to an exemplary embodiment, a hub 508 may be communicatively linked to a fuel dispenser of a service station in a jurisdiction in which fines are levied for having emissions over a certain level. A scanner 506 may broadcast to the hub 508 that the oxygen sensors of the vehicle engine 502 are inoperative, that the vehicle is stuck in an open-loop state, and that the emissions of the vehicle are likely to be over a legal threshold set by the jurisdiction.

The hub 508 may add a fine to the user's fuel bill when the user refuels their vehicle at the fuel dispenser, and may communicate this information to the user, along with a recommendation to repair their sensor. However, the hub 508 may also determine, based on an Internet update, that there is a planned rate increase in the fines to be levied for having emissions over a certain level, and may communicate this information to the user as well, indicating that, for example, it is important for the user to repair their vehicle as soon as possible because the fine to be levied will increase next month. In some exemplary embodiments, the hub 508 may otherwise be configured to notify the user of changes in the law, as may be desired.

Alternatively, the owner of the vehicle may be issued a fine or a ticket in the mail. A picture may also be taken to prove that the vehicle was at the service station. The owner or user may be prompted on, for example, a touchscreen display on the fuel dispenser to acknowledge that they understand that their vehicle is not in compliance and are subjected to pay a fine. The picture could be taken when they push an “Agree” button on the touchscreen display. The fuel dispenser may further include facial recognition and identification devices that may be used by the user to checkout or pay. In another embodiment, the fuel dispenser may require that the person fueling the vehicle to be certified and/or dressed appropriately before they fill the vehicle. A video surveillance system including facial-recognition scan may identify or verify an identity of such a person along with a record of the time/date and amount of fuel for a minimum period of time. The video surveillance system may also be used to confirm that the person is wearing the appropriate safety gear, e.g., gloves, eye protection, and insulated clothing, if necessary.

In another embodiment, the hub 508 may be located at an emissions testing center or a repair facility and provide information about the history of the vehicle's emissions, and report related maintenance performed, and provide a way for a technician to access and reset the OBD-II system of vehicle 500 back to a state of emissions compliance so it can be refueled without penalty.

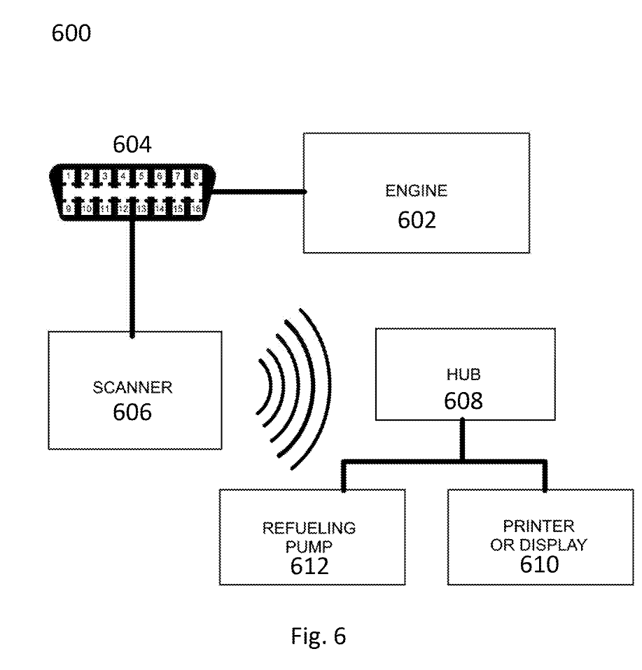

Turning now to exemplary FIG. 6, FIG. 6 displays an exemplary embodiment of a system for remotely monitoring the emissions performance of a vehicle 600. In an exemplary embodiment, a hub 608 may be integrated or retrofitted into, or may otherwise control, a refueling dispenser 612. For example, in an exemplary embodiment, a refueling dispenser 612 may be converted to have a hub 608, and a printer or display 610, integrated within. In another exemplary embodiment, a single hub 608 may control multiple refueling dispensers 612, such as may be desired.

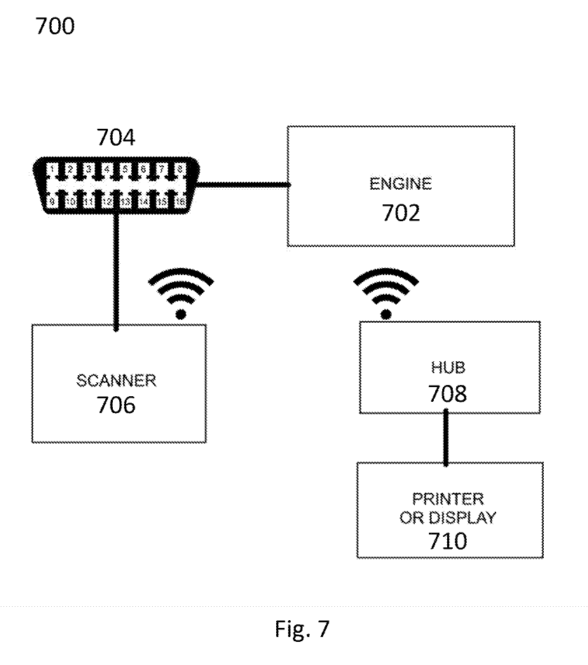

Turning now to exemplary FIG. 7, FIG. 7 displays an exemplary embodiment of a system for remotely monitoring the emissions performance of a vehicle 700. In an exemplary embodiment, a scanner 706 may make use of standard Internet communications or other long-distance communications protocols in order to communicate with a hub 708. In such an exemplary embodiment, the hub 708 may be in a fixed location accessible to a user; for example, in an exemplary embodiment, it may be a home computer of a user, which may receive communications from the scanner 706 and output them as alerts when most likely to be received by the user.

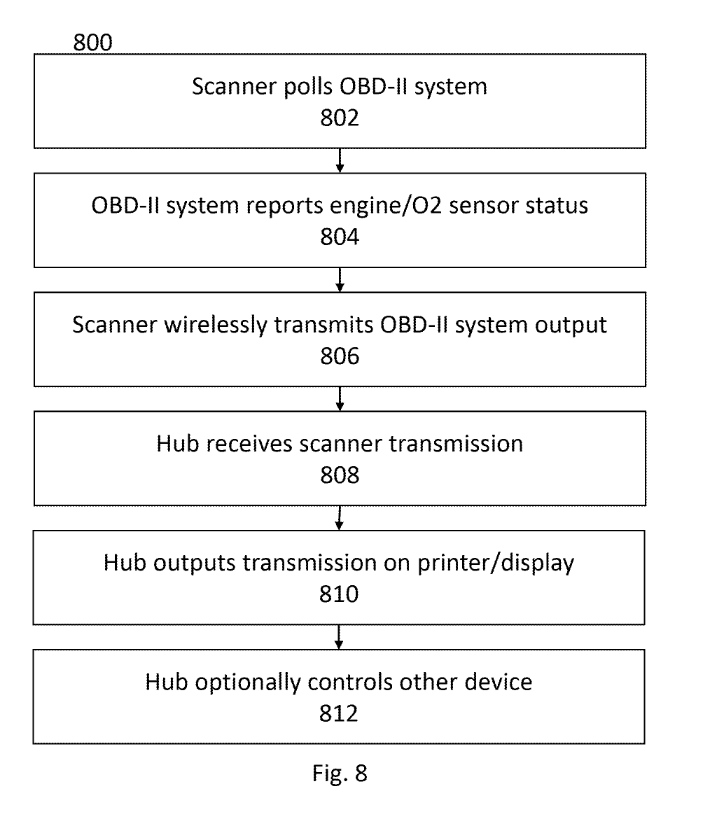

Turning now to exemplary FIG. 8, FIG. 8 displays an exemplary embodiment of a method of using a system for remotely monitoring the emissions performance of a vehicle 800. According to an exemplary embodiment, a scanner may first poll an OBD-II system 802. The OBD-II system may then report the status of the engine or of a sensor of the engine, such as, for example, one or more data values for an oxygen sensor of the engine 804. The scanner may then receive this information and may wirelessly transmit it, for example via a Bluetooth connection, to a hub 806. The hub may then receive this transmission 808 and output the transmission, for example on a printer or on a display 810. The hub may then optionally control another device 812; for example, it may control the operation of a refueling dispenser so that the refueling of a user is limited, or may transmit the scanner information received from the user to another location, such as to the user (so that the user can receive a notification about the state of their engine) or to another party (such as, for example, a municipal government that may be informed that a fine has been levied against the user for failing to comply with emissions requirements based on the state of their engine).

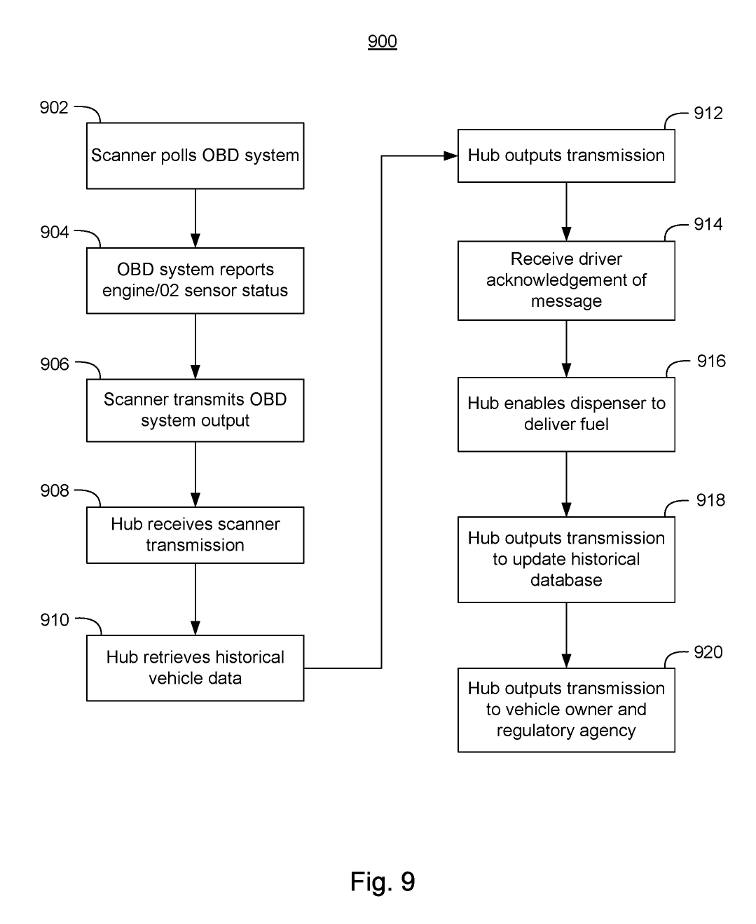

Turning now to exemplary FIG. 9, FIG. 9 displays an exemplary embodiment of a method of using a system for remotely monitoring the emissions performance of a vehicle 900. According to an exemplary embodiment, a scanner may first poll an OBD system 902. The OBD system may then report the status of the engine or of a sensor of the engine, such as, for example, one or more data values for an oxygen sensor of the engine 904. The scanner may then receive this information and may wirelessly transmit it and other information it may have stored, for example via a Bluetooth connection, to a hub 906. The hub may then receive this transmission 908 and may also retrieve historical data from its internal storage or from other remote devices via Internet or other connection 910. The hub may then output the assimilated information, for example on a printer, a display, or the driver's mobile device 912. The driver then acknowledges (e.g., via mobile phone or a display on the hub) the information, such as, for example, confirming that they understand that the vehicle has exceeded the two-week grace period for being out of compliance for emissions and now will require an additional fee for fuel 914. The hub may then optionally control another device 916; for example, it may control the operation of a refueling dispenser so that the refueling of a user is limited. After fueling has been completed the hub may save internally or transmit externally the scanner information received from the vehicle and information about the transaction to another location 918 for historical purposes, then transmit to the driver's mobile device (so that the user can receive a notification about the state of their engine) or to the owner, or to another party (such as, for example, a municipal government that may be informed that a fine has been levied against the user for failing to comply with emissions requirements based on the state of their engine) 920.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for remotely monitoring emissions performance of a vehicle, the method comprising:
receiving information of a vehicle from a scanner coupled to an OBD system of the vehicle, the information including a failure of a sensor,
determining an engine of the vehicle is in a non-compliant state based on the failure information; and
controlling operation of a refueling dispenser based on the failure information, wherein the refueling dispenser presents a message on a display at the refueling dispenser confirming that the vehicle is in the non-compliant state.

2. The method of claim 1 wherein the message includes at least one of a display of additional information recommending how an operator or owner of the vehicle should respond and a notification of a penalty in the form of an additional fee assessed to refuel the vehicle for the non-compliant state.

3. The method of claim 1 further comprising transmitting the information to a remote server via an Internet connection.

4. The method of claim 1 further comprising transmitting an electronic communication to an owner of the vehicle including and levies a fine against an owner of the vehicle in accordance with the non-complaint state. a summary of the non-compliant state

5. The method of claim 1 further comprising contact information for authorized repair shops and average repair prices for remedying the non-compliant state.

6. The method of claim 1 further comprising communication with regulating authorities when the vehicle is out of emissions compliance.
